(19) United States
(12) Patent Application Publication
(10) Pub. No.: US 2022/0335224 A1
(43) Pub. Date: Oct. 20, 2022

(54) WRITING-STYLE TRANSFER BASED ON REAL-TIME DYNAMIC CONTEXT

(71) Applicant: INTERNATIONAL BUSINESS MACHINES CORPORATION, ARMONK, NY (US)

(72) Inventors: Aaron K. Baughman, Cary, NC (US); Shikhar Kwatra, San Jose, CA (US); Diwesh Pandey, Bangalore (IN); Shiladitya Ghosh, Bangalore (IN)

(21) Appl. No.: 17/301,809

(22) Filed: Apr. 15, 2021

(51) Int. Cl. G06F 40/35; G06F 40/109

(52) U.S. Cl. CPC G06F 40/35; G06F 40/109

(57) ABSTRACT

An embodiment for adapting a writing-style based on conversation context is provided. The embodiment may include receiving a plurality of static factors and one or more dynamic real-time factors associated with a conversation between at least two users. The embodiment may also include identifying an initial context of the conversation. The embodiment may further include analyzing the conversation at specified intervals for the one or more dynamic real-time factors. The embodiment may also include in response to determining there is a change in the initial context of the conversation, generating one or more words based on a new context. The embodiment may further include in response to determining there is no change in the initial context of the conversation, generating one or more words based on the initial context. The embodiment may also include suggesting one or more appropriate words to a user based on a current context.

### BACKGROUND

The present invention relates generally to the field of computing, and more particularly to a system for adapting a writing-style based on conversation context.

Writing-style transfer includes re-writing text of a certain style into a new target style during a conversation, such that the style of the text may be changed without changing a core meaning of the conversation. The conversation may be between two users or between a user and a robot via any text-based system, such as a general messaging application. Such conversations present the opportunity to use an assistance mechanism to make the conversation better in terms of effectiveness and cohesiveness. Often, a general tone of the conversation may be classified as either formal or informal, in which word-selection plays a major role in a final outcome of the conversation. Thus, awareness of the conversation context may assist the user with the correct use of words, punctuations, as well as communication speed.

### SUMMARY

According to one embodiment, a method, computer system, and computer program product for adapting a writing-style based on conversation context is provided. The embodiment may include receiving a plurality of static factors and one or more dynamic real-time factors associated with a conversation between at least two users. The embodiment may also include identifying an initial context of the conversation based on the plurality of static factors. The embodiment may further include analyzing the conversation at specified intervals for the one or more dynamic real-time factors. The embodiment may also include in response to determining there is a change in the initial context of the conversation, generating one or more words based on a new context. The embodiment may further include suggesting one or more appropriate words to a user based on a current context of the conversation.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for adapting a writing-style based on conversation context in a real-time dynamic writing-style transfer process according to at least one embodiment.

FIG. 3 is a diagram depicting data received by a context inference engine is shown according to at least one embodiment.

FIG. 4 is a diagram depicting transformers using stacked encoders and decoders according to at least one embodiment.

FIG. 5 is a diagram depicting an operational example of a weight being assigned to a word using the stacked encoders and decoders of FIG. 4 according to at least one embodiment.

FIG. 6 is a functional block diagram of internal and external components of computers and servers depicted in FIG. 1 according to at least one embodiment.

FIG. 7 depicts a cloud computing environment according to an embodiment of the present invention.

FIG. 8 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for adapting a writing-style based on conversation context. The following described exemplary embodiments provide a system, method, and program product to, among other things, identify changes in an initial context of a conversation and, accordingly, suggest appropriate words to a user based on a current context. Therefore, the present embodiment has the capacity to improve the technical field of writing-style transfer by adapting an assistance mechanism to real-time parameters which define a context of a conversation.

As previously described, writing-style transfer includes re-writing text of a certain style into a new target style during a conversation, such that the style of the text may be changed without changing a core meaning of the conversation. The conversation may be between two users or between a user and a robot via any text-based system, such as a general messaging application. Such conversations present the opportunity to use an assistance mechanism to make the conversation better in terms of effectiveness and cohesiveness. Often, a general tone of the conversation may be classified as either formal or informal, in which word-selection plays a major role in a final outcome of the conversation. Thus, awareness of the conversation context may assist the user with the correct use of words, punctuations, as well as communication speed. Conventional conversational systems are limited in the types of information that can be assimilated. This problem is typically addressed by displaying certain information about the other party in a conversation, such as a job title of the other party. However, this information fails to capture the context of the conversation. It may therefore be imperative to have a system in place to identify the context of a conversation and continuously monitor the conversation for any changes in the context. Thus, embodiments of the present invention may provide advantages including, but not limited to, adapting to real-time parameters that define the context of a conversation, continuously monitoring the context of a conversation for any changes in the context, and dynamically switching between formal and informal contexts. The present invention does not require that all advantages need to be incorporated into every embodiment of the invention.

According to at least one embodiment, when two or more users are having a conversation, a plurality of static factors and one or more dynamic real-time factors associated with the conversation may be received so that an initial context of the conversation can be identified. The plurality of static factors may include a relationship between the users and a particular application in use. For example, the application in use may be a general messaging application. The conversation may be analyzed at specified intervals for the one or more dynamic real-time factors in order to determine whether there is a change in the initial context of the conversation. The dynamic real-time factors may include time of day, a surrounding environment of each user, a typing speed of each user, as well as any words and/or emoticons used. According to at least one embodiment, if there is a change in the initial context, one or more words may be generated based on a new context of the conversation. According to at least one other embodiment, if there is no change in the initial context, one or more words may be generated based on the initial context of the conversation. In either embodiment, one or more appropriate words may be suggested to a user based on a current context of the conversation.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to identify changes in an initial context of a conversation and, accordingly, suggest appropriate words to a user based on a current context.

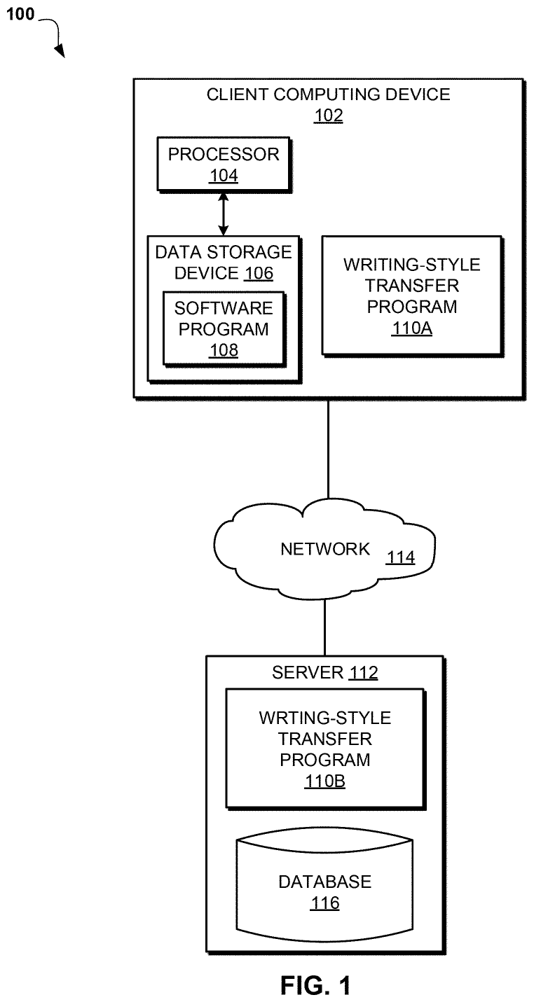

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

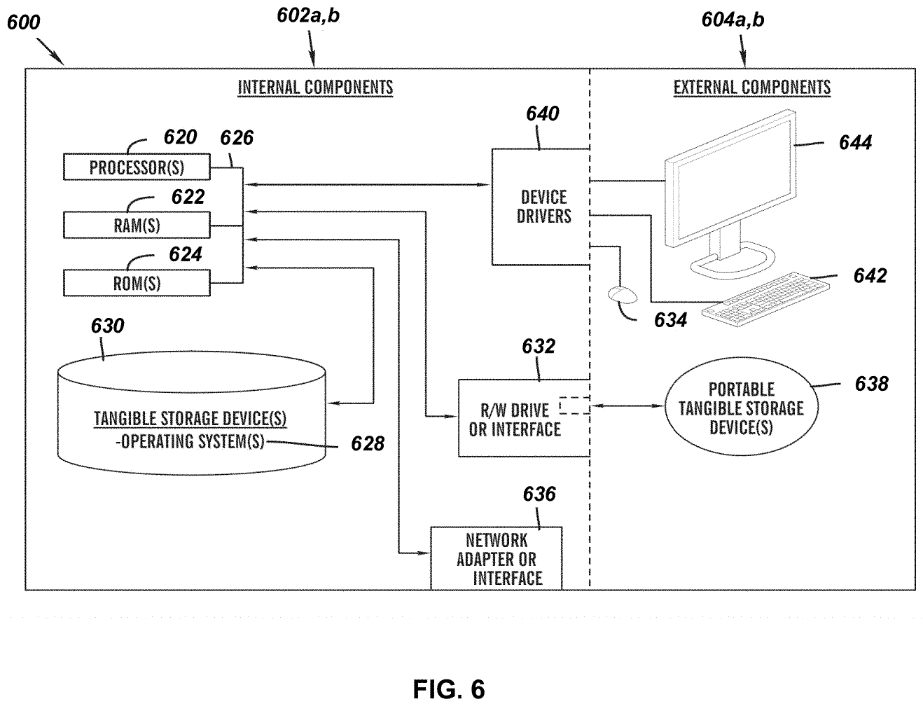

Client computing device 102 may include a processor 104 and a data storage device 106 that is enabled to host and run a software program 108 and a writing-style transfer program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 6, the client computing device 102 may include internal components 602a and external components 604a, respectively.

The server computer 112 may be a laptop computer, netbook computer, personal computer (PC), a desktop computer, or any programmable electronic device or any network of programmable electronic devices capable of hosting and running a writing-style transfer program 110B and a database 116 and communicating with the client computing device 102 via the communication network 114, in accordance with embodiments of the invention. As will be discussed with reference to FIG. 6, the server computer 112 may include internal components 602b and external components 604b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

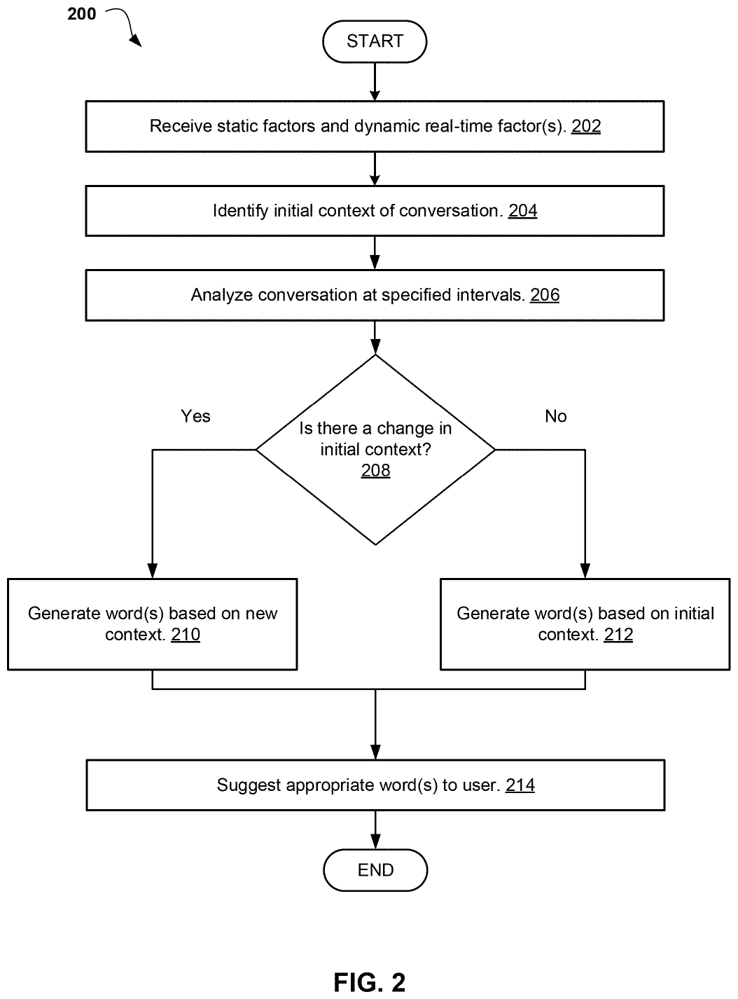

According to the present embodiment, the writing-style transfer program 110A, 110B may be a program capable of receiving static and dynamic real-time factors associated with a conversation, identifying an initial context of the conversation, suggesting appropriate words to a user based on a current context of the conversation, adapting to real-time parameters that define the context of a conversation, continuously monitoring the context of a conversation for any changes in the context, and dynamically switching between formal and informal contexts. The writing-style transfer method is explained in further detail below with respect to FIG. 2.

Referring now to FIG. 2, an operational flowchart for adapting a writing-style based on conversation context in a real-time dynamic writing-style transfer process 200 is depicted according to at least one embodiment. At 202, the writing-style transfer program 110A, 110B receives the plurality of static factors and the one or more dynamic real-time factors associated with the conversation. As used herein, a “conversation” is between at least two users. It may be appreciated that in embodiments of the present invention, even though the conversation is between at least two users, not every user is required to use the writing-style transfer program 110A, 110B. For example, only one user may actually be using the writing-style transfer program 110A, 110B. Prior to use of the writing-style transfer program 110A, 110B, each user may configure the parameters to be used in inferring the initial context of the conversation and any subsequent change in context throughout the conversation. The parameters may include both the static factors and the one or more dynamic real-time factors. The plurality of static factors may include the relationship between the users and the particular application in use. For example, the application in use may be a general messaging application, such as an instant messaging (IM) application like WhatsApp® (WhatsApp and all WhatsApp-based trademarks and logos are trademarks or registered trademarks of Facebook, Inc. and/or its affiliates) and the relationship between the two users may include, but is not limited to, a colleague, a supervisor, a friend, an acquaintance, and a stranger.

According to at least one embodiment, the relationships may be specified by each user through an interface on the client computing device 102. For example, Jim Smith may identify John Doe as his friend, and Bob Johnson as his supervisor. According to at least one other embodiment, the stored contacts of the user may determine the relationship between the users. For example, anyone who is a contact on one user's mobile device may be identified as an acquaintance. According to at least one further embodiment, if it can be derived from the contacts employer information, then users who work for the same employer may be identified as colleagues.

In the present embodiment, the static factors may be used to determine the initial context of the conversation, described in further detail below with respect to step 204. The one or more dynamic real-time factors may include the time of day, the surrounding environment of each user, the typing speed of each user, as well as any words and/or emoticons used by each user. In embodiments of the present invention, a threshold typing speed, such as 40 words per minute (WPM), may be used to determine a change in the initial context as well as any subsequent change in context after the change in the initial context. The dynamic real-time factors may be used to determine any change in the initial context of the conversation, and any subsequent change after the change in the initial context, described in further detail below with respect to step 208.

Then, at 204, the writing-style transfer program 110A, 110B identifies the initial context of the conversation. The initial context of the conversation is based on the plurality of static factors described above with respect to step 202. In embodiments of the present invention, the “context” of the conversation can be classified as either “formal” or “informal.”

For example, the initial context in an online dating application between two strangers may be classified as “formal,” whereas if the conversation in the dating application is between two acquaintances, the initial context may be classified as “informal.” Continuing the example, the initial context in an office communicator application between two friends may be classified as “informal,” whereas if the conversation in the office communicator application is between an employee and a supervisor, the initial context may be classified as “formal.” In a further example, the initial context in a general messaging application between two colleagues or two strangers may be classified as “formal,” whereas if the conversation in the general messaging application is between two friends or acquaintances, the initial context may be classified as “informal.” Thus, a static parameter tuple <relationship, application> may be used in identifying the initial context of the conversation. It may be appreciated that in embodiments of the present invention the users may customize the initial context associated with each static parameter tuple using the interface of the client computing device 102 described above with respect to step 202. For example, in the office communicator application, the users may choose the conversation between an employee and a supervisor to be classified as “informal” rather than the default, which would be “formal.”

Next, at 206, the writing-style transfer program 110A, 110B analyzes the conversation at specified intervals for the one or more dynamic real-time factors. As described above with respect to step 202, the one or more dynamic real-time factors may include the time of day, the surrounding environment of each user, the typing speed of each user, as well as any words and/or emoticons used by each user. According to at least one embodiment, the specified intervals for analyzing the conversation may be time-based and selected by the users via the interface of the client computing device 102 described above with respect to step 202. For example, the time-based interval may be thirty seconds, sixty seconds, five minutes, or any other time period chosen by the user. According to at least one other embodiment, the specified intervals for analyzing the conversation may be based on logical division of the conversation. For example, the analyzation may occur after each question that is asked by one of the users.

In the present embodiment, at 208, the writing-style transfer program 110A, 110B determines whether there is a change in the initial context of the conversation. The change in the initial context is determined based on the one or more dynamic real-time factors. It may be appreciated that if there is not enough data from the one or more dynamic real-time factors to detect a change in the initial context, the initial context of the conversation may be assumed to be “formal.”

Continuing any of the examples above where the initial context is classified as “formal,” if either user begins using emoticons in the conversation, the writing-style transfer program 110A, 110B may determine there is a change in the initial context and switch the context from “formal” to “informal.” Continuing any of the examples above where the initial context is classified as “informal,” and where the threshold typing speed is 40 WPM, if either user slows their typing speed from 45 WPM to 35 WPM, the writing-style transfer program 110A, 110B may determine there is a change in the initial context and switch the context from “informal” to “formal.” In a further example, the surrounding environment of each user may be used to determine whether there is a change in the initial context. In the example, if the initial context is classified as informal, but one or both of the users is in an office, the writing-style transfer program 110A, 110B may determine there is a change in the initial context and may switch the context from “informal” to “formal.” It may be appreciated that the conversation may be continuously monitored at the specified intervals for a subsequent change in context even after the change in the initial context of the conversation. Continuing the example where one user's typing speed went from 45 WPM to 35 WPM, if the user's typing speed then increases back to 45 WPM, the writing-style transfer program may determine there is a change in the initial context and a subsequent change in context, and switch the context from “informal” to “formal” and then back to “informal.”

In response to determining there is a change in the initial context of the conversation (step 208, “Yes” branch), the real-time dynamic writing-style transfer process 200 may proceed to step 210 to generate the one or more words based on the new context of the conversation. In response to determining there is no change in the initial context of the conversation (step 208, “No” branch), the real-time dynamic writing-style transfer process 200 may proceed to step 212 to generate the one or more words based on the initial context of the conversation.

Then, at 210, in response to determining there is a change in the initial context, the writing-style transfer program 110A, 110B generates the one or more words based on the new context of the conversation. As used herein, a “new context” means any change in the initial context as well as any subsequent change in context after the change in the initial context.

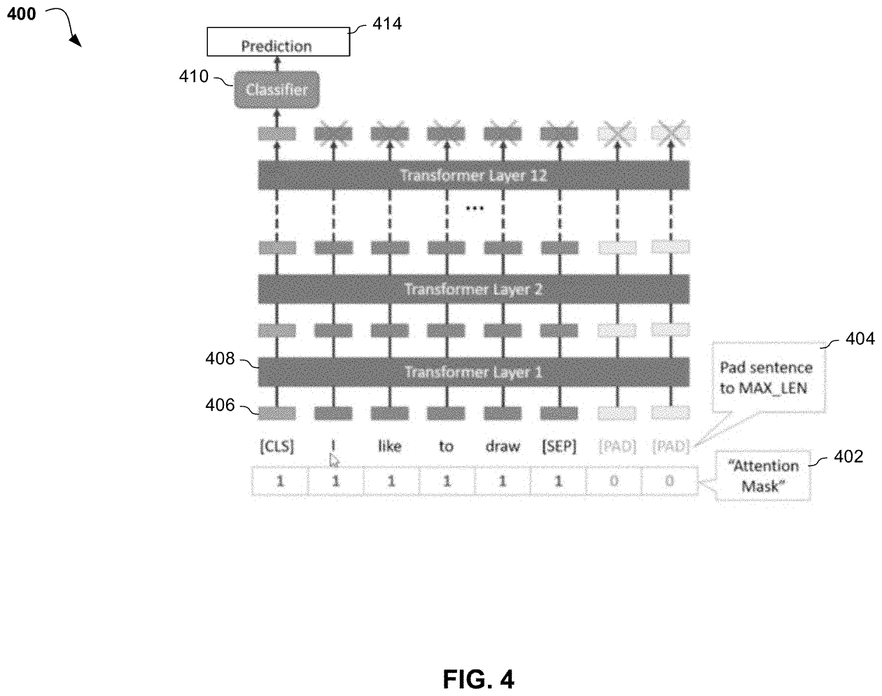

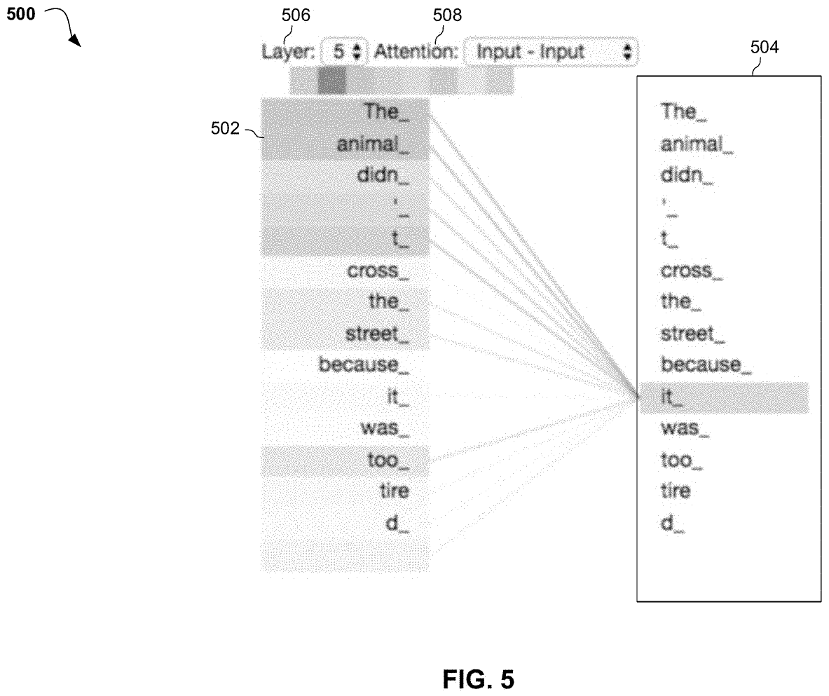

The writing-style transfer program 110A, 110B may utilize a natural language processing (NLP) engine and a generative adversarial network (GAN) in order to generate the one or more words based on the new context. The GAN may create new text given the topic of the conversation and the context of the conversation. For example, in a “formal” context, it may be desirable to develop a substitute for the word “it.” Details on developing substitutes for “it” in accordance with exophora negation are described in further detail below with respect to FIG. 5. Details on the NLP engine are described in further detail below with respect to FIGS. 4 and 5.

According to at least one embodiment, the generated word or words may be a synonym for a word or words used by each user. For example, if there is a change in the initial context from “informal” to “formal,” and one user used the phrase “do this assignment,” the writing-style transfer program 110A, 110B may generate a more formal word for “do,” such as “review this assignment.” Conversely, if there is a change in the initial context from “formal” to “informal,” and one user used the phrase “review this assignment,” the writing-style transfer program 110A, 110B may generate a more informal word for “review,” such as “do.” According to at least one other embodiment, the generated word or words may be an addition to the word or words used by each user. Continuing the example above where there is a change in the initial context from “informal” to “formal,” and one user used the phrase “do this assignment,” the writing-style transfer program 110A, 110B may generate more formal words, such as “please review this assignment.” According to at least one further embodiment, the generated word or words may include a change in the font, and/or a change in a characteristic of the font of the word or words used by each user. Examples of characteristics of the font include, but are not limited to, bolding, unbolding, italicizing, underlining, and size. For example, if there is a change in the initial context from “formal” to “informal,” and one user used the phrase “good luck at the game today” in 12-point font, the writing-style transfer program 110A, 110B may generate a larger font for the word or words, such as 14-point font. Furthermore, the word or words may also be bolded for emphasis. Conversely, where the initial context changes from “informal” to “formal,” the above word or words may be unbolded and the font size may be reduced.

Next, at 212, in response to determining there is no change in the initial context, the writing-style transfer program 110A, 110B generates the one or more words based on the initial context of the conversation. The writing-style transfer program 110A, 110B may utilize the natural language processing (NLP) engine and the GAN described above with regard to step 210 in order to generate the one or more words based on the initial context. Additionally, the embodiments and examples described in step 210 are also applicable to step 212. However, in step 212, the generated one or more words may be based only on the initial context. For example, if there is no change in the initial context from “informal” to “formal,” and one user used the phrase “do this assignment,” the writing-style transfer program 110A, 110B may generate another informal word for “do,” such as “look at this assignment.” In another example, if there is no change in the initial context from “formal” to “informal,” and one user used the phrase “good luck at the game today” in bold and in 14-point font, the writing-style transfer program 110A, 110B may generate a word or words consistent with a “formal” context, such as reducing and unbolding the font to just “good luck at the game today.”

Then, at 214, the writing-style transfer program 110A, 110B suggests the one or more appropriate words to the user. The one or more appropriate words may be selected from the generated one or more words described above with respect to steps 210 and 212, and may be displayed to each user as a “pop-up” on each user's device. The one or more appropriate words may be suggested based on a current context of the conversation. As used herein, a “current context” means the time at which each user transcribes the word or words used in the conversation. The current context takes into account all changes in the context starting with the change in the initial context. Since the conversation may be continuously monitored at the specified intervals for a subsequent change in context even after the change in the initial context as described above with respect to step 208, the context may switch from “informal” to “formal” and then back to “informal.” In such a case, the current context may be classified as “informal.” In cases where there is no change in the initial context, the current context may be the initial context. Thus, where there is no change in the initial context of the conversation, the one or more appropriate words may be the word or words generated above with respect to step 212. Conversely, where there is a change in the initial context of the conversation, the one or more appropriate words may be the word or words generated above with respect to step 210.

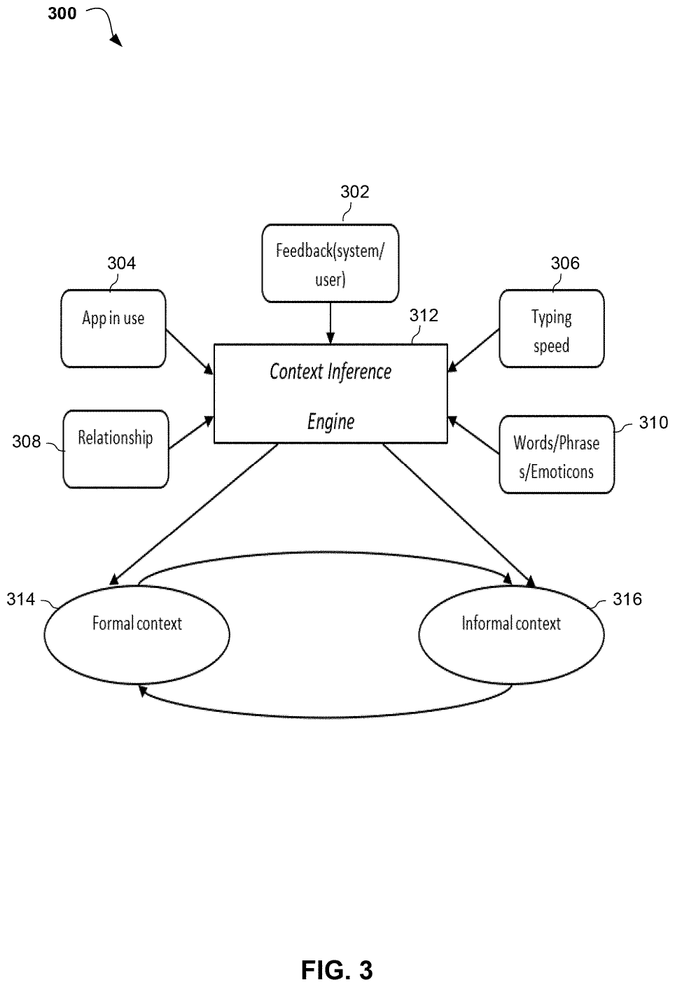

Referring now to FIG. 3, a diagram 300 depicting data received by a context inference engine 312 is shown according to at least one embodiment. The context inference engine 312 may receive a variety of data to identify the initial context of the conversation and determine whether there is any change in the initial context, such as from the formal context 314 to the informal context 316, or from the informal context 316 to the formal context 314. The context inference engine 312 may also continuously monitor the conversation for any subsequent changes in context after the change in the initial context, and throughout the conversation switch between the formal context 314 and the informal context 316. The data may include the plurality of static factors, such as the application in use 304 and the relationship between the users 308, as well as the one or more dynamic real-time factors, such as the typing speed of each user 306 and the words and/or emoticons 310 used in the conversation. Additionally, historical data (not shown) and feedback 302 may be received by the context inference engine 312. For example, if one of the users overrides a context switch, the user may send the feedback 302 to the context inference engine 312 that the identified change in context is incorrect. This historical data (not shown) may then be mined in the future for more accurate identification of any changes in the context of the conversation.

Referring now to FIG. 4, a diagram 400 depicting the NLP engine using transformers 408 and stacked encoders and decoders 406 to generate the one or more words based on the new context or the initial context is shown according to at least one embodiment. Traditional transformers 408 may use six encoders and decoders 406, each of which has a self-attention mechanism that may determine weights for a summation of word embeddings which are input into activation functions. An encoder of the encoders and decoders 406 may map an input sequence to its continuous representation, which may then be used by a decoder of the encoders and decoders 406 to generate output. A final state of the encoder of the encoders and decoders 406 may be a fixed-size vector which encodes a source sentence, including the sentence meaning. In the encoder phase, the transformers 408 may generate an initial embedding for each word in the sentence or phrase. The self-attention mechanism may determine on which words to focus within the context of the other words in the sentence or phrase while negating exophoric words, described in further detail below with respect to FIG. 5. In this manner, a new representation may be created for each word, which may then be decoded into actual words by the decoder. An attention mask 402 may be used to determine if the word is relevant within each upcoming transformer layer, e.g., from transformer layer 1 to transformer layer 2, from transformer layer 2 to transformer layer 3 (not shown), and so on until transformer layer 12 is reached. For example, the sentence “I like to draw” may be separated and padded to MAX_LENGTH 404. The word embeddings for this sentence may pass through each of the transformer layers 408 and a classifier 410 may make a prediction 414 on the one or more words to be generated based on whether the context is new or the same as the initial context.

Referring now to FIG. 5, a diagram 500 depicting an operational example of a weight being assigned to a word using the stacked encoders and decoders 406 of FIG. 4 is shown according to at least one embodiment. In the example, the sentence “The animal didn't cross the street because it was too tired” is presented. Also, in the example, it is shown that the attention 508 is set to “Input—Input” and the layer 506 is set to “5”. Consistent with exophora negation, edge weights may be utilized to determine the words which most correlate to “it”. The diagram 500 shows a left column 502 and a right column 504, in which “it” in the right column 504 is correlated with each of “The,” “animal,” “didn,” “',” “t,” “cross,” “the,” “street,” “because,” “it,” “was,” “too,” “tire,” and “d.” The thicker lines in the diagram 500 show the words in the left column 502 that are most correlated with “it” on the right column 504. Thus, in this operational example, the one or more words generated which may substitute for “it” are “The animal.” A discriminator (not shown) takes the current context of the conversation into account, and determines whether “The animal” is appropriate within the given current context. In this manner, the focus on irrelevant words in the conversation may be reduced, and a more appropriate word may be suggested to each user based on the current context of the conversation.

It may be appreciated that FIGS. 2-5 provide only an illustration of one implementation and do not imply any limitations with regard to how different embodiments may be implemented. Many modifications to the depicted environments may be made based on design and implementation requirements.

FIG. 6 is a block diagram 600 of internal and external components of the client computing device 102 and the server 112 depicted in FIG. 1 in accordance with an embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

The data processing system 602, 604 is representative of any electronic device capable of executing machine-readable program instructions. The data processing system 602, 604 may be representative of a smart phone, a computer system, PDA, or other electronic devices. Examples of computing systems, environments, and/or configurations that may represented by the data processing system 602, 604 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 602 a,b and external components 604 a,b illustrated in FIG. 6. Each of the sets of internal components 602 include one or more processors 620, one or more computer-readable RAMs 622, and one or more computer-readable ROMs 624 on one or more buses 626, and one or more operating systems 628 and one or more computer-readable tangible storage devices 630. The one or more operating systems 628, the software program 108 and the writing-style transfer program 110A in the client computing device 102 and the writing-style transfer program 110B in the server 112 are stored on one or more of the respective computer-readable tangible storage devices 630 for execution by one or more of the respective processors 620 via one or more of the respective RAMs 622 (which typically include cache memory). In the embodiment illustrated in FIG. 6, each of the computer-readable tangible storage devices 630 is a magnetic disk storage device of an internal hard drive. Alternatively, each of the computer-readable tangible storage devices 630 is a semiconductor storage device such as ROM 624, EPROM, flash memory or any other computer-readable tangible storage device that can store a computer program and digital information.

Each set of internal components 602 a,b also includes a RAY drive or interface 632 to read from and write to one or more portable computer-readable tangible storage devices 638 such as a CD-ROM, DVD, memory stick, magnetic tape, magnetic disk, optical disk or semiconductor storage device. A software program, such as the writing-style transfer program 110A, 110B, can be stored on one or more of the respective portable computer-readable tangible storage devices 638, read via the respective R/W drive or interface 632, and loaded into the respective hard drive 630.

Each set of internal components 602 a,b also includes network adapters or interfaces 636 such as a TCP/IP adapter cards, wireless Wi-Fi interface cards, or 3G or 4G wireless interface cards or other wired or wireless communication links. The software program 108 and the writing-style transfer program 110A in the client computing device 102 and the writing-style transfer program 110B in the server 112 can be downloaded to the client computing device 102 and the server 112 from an external computer via a network (for example, the Internet, a local area network or other, wide area network) and respective network adapters or interfaces 636. From the network adapters or interfaces 636, the software program 108 and the writing-style transfer program 110A in the client computing device 102 and the writing-style transfer program 110B in the server 112 are loaded into the respective hard drive 630. The network may comprise copper wires, optical fibers, wireless transmission, routers, firewalls, switches, gateway computers and/or edge servers.

Each of the sets of external components 604 a,b can include a computer display monitor 644, a keyboard 642, and a computer mouse 634. External components 604 a,b can also include touch screens, virtual keyboards, touch pads, pointing devices, and other human interface devices. Each of the sets of internal components 602 a,b also includes device drivers 640 to interface to computer display monitor 644, keyboard 642, and computer mouse 634. The device drivers 640, R/W drive or interface 632, and network adapter or interface 636 comprise hardware and software (stored in storage device 630 and/or ROM 624).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

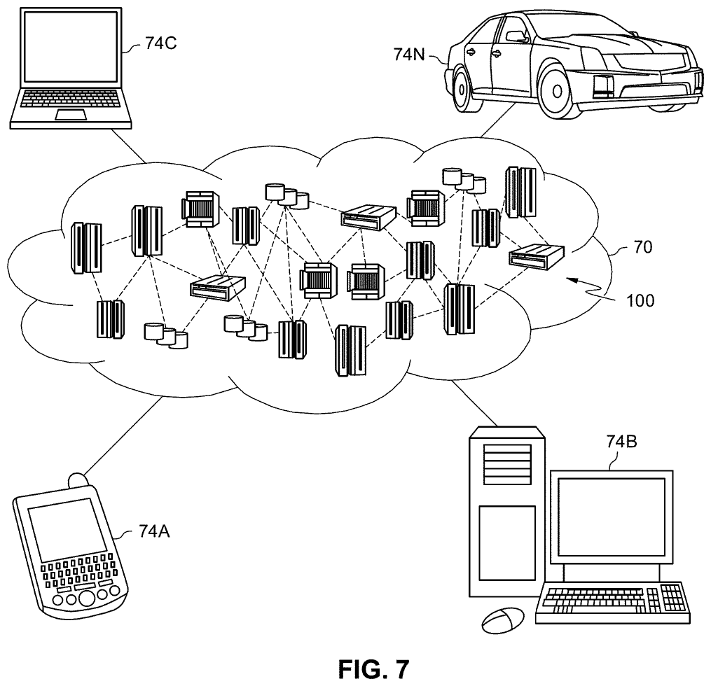

Referring now to FIG. 7, illustrative cloud computing environment 70 is depicted. As shown, cloud computing environment 70 comprises one or more cloud computing nodes 100 with which local computing devices used by cloud consumers, such as, for example, personal digital assistant (PDA) or cellular telephone 74A, desktop computer 74B, laptop computer 74C, and/or automobile computer system 74N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 70 to offer infrastructure, platforms and/or software as services for which a cloud consumer does not need to maintain resources on a local computing device. It is understood that the types of computing devices 74A-N shown in FIG. 7 are intended to be illustrative only and that computing nodes 100 and cloud computing environment 70 can communicate with any type of computerized device over any type of network and/or network addressable connection (e.g., using a web browser).

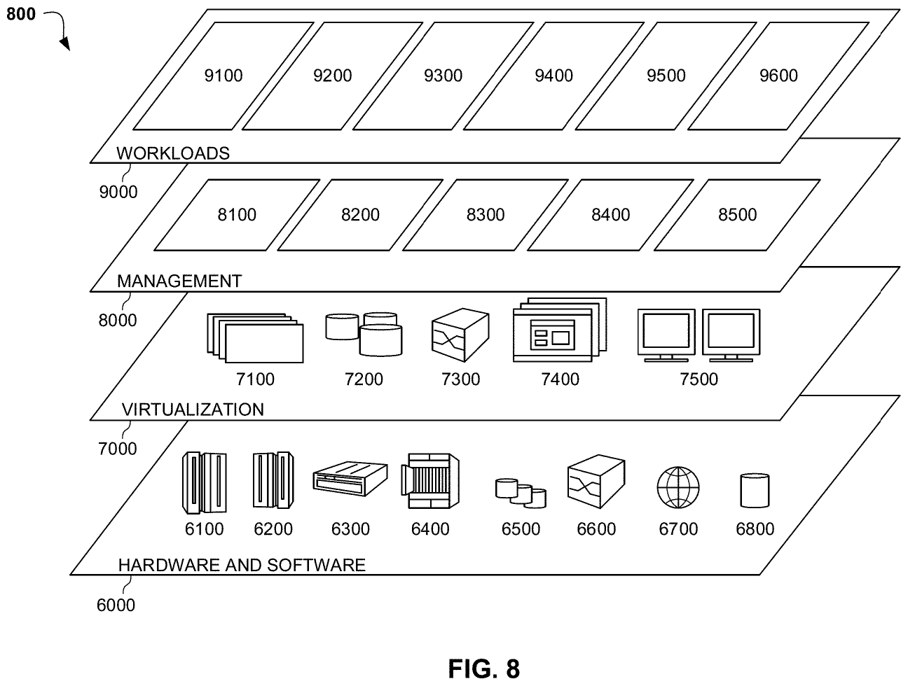

Referring now to FIG. 8, a set of functional abstraction layers 800 provided by cloud computing environment 70 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 6000 includes hardware and software components. Examples of hardware components include: mainframes 6100; RISC (Reduced Instruction Set Computer) architecture based servers 6200; servers 6300; blade servers 6400; storage devices 6500; and networks and networking components 6600. In some embodiments, software components include network application server software 6700 and database software 6800.

Virtualization layer 7000 provides an abstraction layer from which the following examples of virtual entities may be provided: virtual servers 7100; virtual storage 7200; virtual networks 7300, including virtual private networks; virtual applications and operating systems 7400; and virtual clients 7500.

In one example, management layer 8000 may provide the functions described below. Resource provisioning 8100 provides dynamic procurement of computing resources and other resources that are utilized to perform tasks within the cloud computing environment. Metering and Pricing 8200 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 8300 provides access to the cloud computing environment for consumers and system administrators. Service level management 8400 provides cloud computing resource allocation and management such that required service levels are met. Service Level Agreement (SLA) planning and fulfillment 8500 provide pre-arrangement for, and procurement of, cloud computing resources for which a future requirement is anticipated in accordance with an SLA.

Workloads layer 9000 provides examples of functionality for which the cloud computing environment may be utilized. Examples of workloads and functions which may be provided from this layer include: mapping and navigation 9100; software development and lifecycle management 9200; virtual classroom education delivery 9300; data analytics processing 9400; transaction processing 9500; and adapting a writing-style based on conversation context 9600. Adapting a writing-style based on conversation context 9600 may relate to identifying changes in an initial context of a conversation in order to suggest appropriate words to a user based on a current context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of adapting a writing-style based on conversation context, the method comprising:
receiving a plurality of static factors and one or more dynamic real-time factors associated with a conversation between at least two users;
identifying an initial context of the conversation based on the plurality of static factors;
analyzing the conversation at specified intervals for the one or more dynamic real-time factors;
determining whether there is a change in the initial context of the conversation based on the one or more dynamic real-time factors; and
in response to determining there is a change in the initial context of the conversation, generating one or more words based on a new context of the conversation.

2. The method of claim 1, further comprising:
in response to determining there is no change in the initial context of the conversation, generating one or more words based on the initial context of the conversation.

3. The method of claim 2, further comprising:
suggesting one or more appropriate words, from the generated one or more words, to a user based on a current context of the conversation.

4. The method of claim 3, wherein suggesting the one or more appropriate words to the user further comprises:
continuously monitoring the conversation at the specified intervals for a subsequent change in context after the change in the initial context of the conversation.

5. The method of claim 1, wherein the dynamic real-time factor is selected from a group consisting of a time of day, a surrounding environment of each user, a typing speed of each user, a word inputted by each user, and an emoticon.

6. The method of claim 1, wherein generating the one or more words based on the new context of the conversation further comprises:
generating a new font or a characteristic of the font for the one or more words that is consistent with the new context of the conversation.

7. The method of claim 1, wherein the plurality of static factors includes a relationship between the users and a particular application in use.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a plurality of static factors and one or more dynamic real-time factors associated with a conversation between at least two users;
identifying an initial context of the conversation based on the plurality of static factors;
analyzing the conversation at specified intervals for the one or more dynamic real-time factors;
determining whether there is a change in the initial context of the conversation based on the one or more dynamic real-time factors; and
in response to determining there is a change in the initial context of the conversation, generating one or more words based on a new context of the conversation.

9. The computer system of claim 8, further comprising:
in response to determining there is no change in the initial context of the conversation, generating one or more words based on the initial context of the conversation.

10. The computer system of claim 9, further comprising:
suggesting one or more appropriate words, from the generated one or more words, to a user based on a current context of the conversation.

11. The computer system of claim 10, wherein suggesting the one or more appropriate words to the user further comprises:
continuously monitoring the conversation at the specified intervals for a subsequent change in context after the change in the initial context of the conversation.

12. The computer system of claim 8, wherein the dynamic real-time factor is selected from a group consisting of a time of day, a surrounding environment of each user, a typing speed of each user, a word inputted by each user, and an emoticon.

13. The computer system of claim 8, wherein generating the one or more words based on the new context of the conversation further comprises:
generating a new font or a characteristic of the font for the one or more words that is consistent with the new context of the conversation.

14. The computer system of claim 8, wherein the plurality of static factors includes a relationship between the users and a particular application in use.

15. A computer program product, the computer program product comprising:
one or more computer-readable tangible storage medium and program instructions stored on at least one of the one or more tangible storage medium, the program instructions executable by a processor capable of performing a method, the method comprising:
receiving a plurality of static factors and one or more dynamic real-time factors associated with a conversation between at least two users;
identifying an initial context of the conversation based on the plurality of static factors;
analyzing the conversation at specified intervals for the one or more dynamic real-time factors;
determining whether there is a change in the initial context of the conversation based on the one or more dynamic real-time factors; and
in response to determining there is a change in the initial context of the conversation, generating one or more words based on a new context of the conversation.

16. The computer program product of claim 15, further comprising:
in response to determining there is no change in the initial context of the conversation, generating one or more words based on the initial context of the conversation.

17. The computer program product of claim 16, further comprising:
suggesting one or more appropriate words, from the generated one or more words, to a user based on a current context of the conversation.

18. The computer program product of claim 17, wherein suggesting the one or more appropriate words to the user further comprises:
continuously monitoring the conversation at the specified intervals for a subsequent change in context after the change in the initial context of the conversation.

19. The computer program product of claim 15, wherein the dynamic real-time factor is selected from a group consisting of a time of day, a surrounding environment of each user, a typing speed of each user, a word inputted by each user, and an emoticon.

20. The computer program product of claim 15, wherein generating the one or more words based on the new context of the conversation further comprises:
generating a new font or a characteristic of the font for the one or more words that is consistent with the new context of the conversation.
